(19) United States
(12) Patent Application Publication
(10) Pub. No.: US 2024/0351410 A1
(43) Pub. Date: Oct. 24, 2024

(54) VEHICLE ROOF SYSTEM AND METHOD FOR MOUNTING A VEHICLE ROOF SYSTEM

(71) Applicant: Webasto SE, Stockdorf (DE)

(72) Inventors: Stefan MIKLOSI, Stockdorf (DE); Mattias HIRVONEN, Stockdorf (DE); Florian GROßER, Stockdorf (DE); Christian RAUCH, Stockdorf (DE)

(21) Appl. No.: 18/631,635

(22) Filed: Apr. 10, 2024

(30) Foreign Application Priority Data
Apr. 19, 2023 (DE) 10 2023 109 892.6

(51) Int. Cl. B60J 7/16; B62D 27/02; B62D 29/00

(52) U.S. Cl. CPC B60J 7/16; B62D 27/023; B62D 29/001

(57) ABSTRACT

In a vehicle roof system and a method for mounting such a vehicle roof system, the vehicle roof system has a front roof module and a rear roof module, wherein the front roof module has a front frame and the rear roof module has a rear frame. The rear roof module fixedly closes a rear region of a roof opening or a rear roof opening, and the front roof module can partly expose or completely close a front region of the roof opening or a front roof opening by a displaceable cover. A central strut part is arranged between the two roof modules, transversely with respect to a vehicle longitudinal axis. A reinforcing plate is foamed or bonded on the rear roof module and is connected to the front frame or to the rear frame, in particular riveted, screwed or bonded, wherein the reinforcing plate forms the central strut part.

### CROSS-REFERENCE TO RELATED APPLICATION(S)

This application claims the benefit of German Patent Application No. 10 2023 109 892.6 filed Apr. 19, 2023, which is incorporated herein by reference in its entirety.

### TECHNICAL FIELD

The present invention relates to a vehicle roof system for mounting on a vehicle roof, wherein the vehicle roof system has a front roof module and a rear roof module, wherein the front roof module has a front frame and the rear roof module as a rear frame, and the rear roof module fixedly closes a rear region of a roof opening of the vehicle roof or a rear roof opening, and the front roof module can partly expose or completely close a front region of the roof opening or a front roof opening by means of a displaceable cover, wherein a central strut part is arranged between the two roof modules, transversely with respect to a vehicle longitudinal axis. The present invention also relates to a method for mounting such a vehicle roof system.

### BACKGROUND

A vehicle roof system of the generic type includes a front roof module and a rear roof module, wherein the front roof module has a front frame and the rear roof module has a rear frame. The rear roof module is provided to fixedly close a rear region of a roof opening or a rear roof opening. The front roof module can partly expose or completely close a front region of the roof opening or a front roof opening by means of a displaceable cover. Between the two roof modules, a central strut part is arranged transversely with respect to a vehicle longitudinal axis.

### SUMMARY

A problem of such known vehicle roofs is the complexity of the mounting. In particular in a “top-load” (TL) system, in which the cover and a fixed glass element are mounted on the vehicle roof system from above, the assembly is more complicated with respect to some aspects than a “bottom-load” (BL) system, in which these elements are arranged from the vehicle interior. The terms “from above” and “from below” are to be understood here and in the following text as the directions as understood in a finally produced vehicle in the usual orientation.

In known TL vehicle roofs, a covering which is used for occupant protection in the event of a head impact and as a screen is arranged here retrospectively on the underside of the central strut part.

It is therefore an object of the present invention to devise a vehicle roof system in which the mounting is simplified.

This object is achieved by a vehicle roof system in which a reinforcing plate is foamed or bonded on the rear roof module and is connected to the front frame or to the rear frame, in particular riveted, screwed or bonded, wherein the reinforcing plate forms the central strut part. This object is also achieved by a method in which the front frame and the rear frame are arranged in the region of the roof opening, and then a fixed glass element of the rear roof module is inserted into the roof opening from above and connected to a frame transverse component by means of the reinforcing plate, in particular riveted, screwed or bonded, wherein the frame transverse component is formed on the front frame in a rear region in the direction of travel or on the rear frame in a front region in the direction of travel, preferably perpendicularly and transversely with respect to the vehicle longitudinal axis.

According to the invention, a reinforcing plate is foamed or bonded on the rear roof module and is connected to the front frame or to the rear frame, in particular riveted, screwed or bonded, wherein the reinforcing plate forms the central strut part.

The reinforcing plate can thus be foamed or bonded to the rear roof module even before the mounting and connected to the front frame or rear frame before or during the mounting, in particular riveted, screwed or bonded. The connection is therefore made in particular with an entire frame component, which has the front and rear frame. The reinforcing plate forms the central strut part.

This simplifies the mounting in particular of TL vehicle roofs, since the number of components to be mounted during the final mounting, for example at a vehicle manufacturer, is reduced.

Preferred refinements of the vehicle roof system of the present invention may include the following features.

The front frame has a frame transverse component in a rear region in the direction of travel or the rear frame has a frame transverse component in a front region in the direction of travel, to which the reinforcing plate is connected, in particular riveted, screwed or bonded.

The front frame is designed to run around the front region of the roof opening or the front roof opening.

The rear frame is arranged in the region of the side edges and the rear edge of the rear region of the roof opening or the rear roof opening.

The front frame and the rear frame form a unified roof frame, which is designed as an 8-shaped frame component, and the reinforcing plate is connected to this frame component, in particular riveted, screwed or bonded.

The reinforcing plate is designed as a hollow body with an upper part which forms the central strut part, and a lower part which faces a vehicle interior, wherein the upper and lower part are designed as an integral component or, alternatively, form two preferably welded shells connected to each other.

The reinforcing plate has a foam surround, at least on an underside which faces a vehicle interior.

The reinforcing plate is foamed to the rear roof module by means of the foam surround, and the foam surround also forms a marginal foam surround of a fixed glass element of the rear roof module.

The reinforcing plate is bonded to a fixed glass element of the rear roof module.

The two roof modules are designed to be mounted in or on the roof opening or the roof openings from a region outside a vehicle interior.

The displaceable cover has a glass pane, and the rear roof module has a fixed glass element, and the two roof modules are formed such that the displaceable cover and the fixed glass element can be mounted in or on the roof opening from above.

The vehicle roof system is a spoiler roof, in which a displaceable cover of the front roof module can be displaced at least partly over a fixed glass element of the rear roof module to partly expose the roof opening.

The reinforcing plate is bonded or screwed or riveted from below onto the front or rear frame or on a frame component which has the front and the rear frame.

In a preferred refinement of the method for mounting a vehicle roof system of the present invention, the region of the central strut part, the front frame or the rear frame has the frame transverse component, to the underside of which an upper side of the reinforcing plate is connected, preferably bonded, screwed or riveted.

In a first preferred embodiment of the invention, the front frame of the front roof module has a frame transverse component in a rear region in the direction of travel, to which the central strut part of the rear roof module is connected before or during the installation of the rear roof module, preferably during the mounting of a fixed glass element of the rear roof module. Alternatively, the rear frame can also have the frame transverse component in a front region. The frame transverse component and the reinforcing plate connected thereto and having the central strut component advantageously increase the stability of the vehicle roof system and the torsional rigidity of the entire vehicle.

The front frame can be designed to run around the front region of the roof opening or the front roof opening.

The rear frame is preferably arranged in the region of the side edges and the rear edge of the rear region of the roof opening or the rear roof opening.

In principle, a roof opening, on which the front frame and the rear frame are arranged, can be provided on a vehicle, wherein the front roof opening is formed by the front frame and the rear roof opening is formed by the rear frame, and the front frame and the rear frame are arranged on a roof opening.

In a further preferred refinement of the invention, the front frame and the rear frame are designed as an 8-shaped frame component, wherein the front frame and the rear frame form the frame component. This is to be understood to mean that a (for example preassembled) 8-shaped frame component is arranged on the vehicle roof system such that the vehicle roof system comprises a roof opening (in the sense of a periphery) and divides the latter into two roof opening regions by using the front frame and the rear frame. The frame transverse component subdivides the roof opening into the two roof opening regions. The frame component can be formed in one piece and/or integrally. Alternatively, the frame component can comprise at least the front frame and the rear frame, which are connected to each other.

The frame transverse component can alternatively be arranged at the rear on the front frame or at the front on the rear frame, or formed from two separate individual components arranged in such a way.

Of course, however, a front frame and a rear frame can also be mounted separately in such a way that they form the 8-shaped frame structure only when installed.

Particularly preferred is an embodiment in which the reinforcing plate is designed as a hollow body. This increases the stability and the torsional rigidity of this element. Here, an upper part of the reinforcing plate forms the central strut part which, during the mounting of the rear roof module, is connected, in particular bonded, to the frame transverse component of the front roof module. A lower part of the reinforced plate faces a vehicle interior when installed. The upper and lower part preferably represent two shells connected to each other, which, for example, can be welded to each other. Alternatively, the reinforcing plate can also be produced in one piece, for example in the form of a tube, a square tube or a curved plate.

Furthermore, the reinforcing plate can preferably have a foam surround, at least on the underside which faces a vehicle interior. This offers the advantage that the necessary head impact protection can be provided without the complicated mounting of an additional cover. Furthermore, only the reinforcing plate must at least partially be surrounded with foam and not the entire front or rear frame or the entire frame component. Therefore, the complexity of the injection moulding tool can be reduced.

In a further embodiment of the invention, the reinforcing plate is also foamed onto the rear roof module by means of the same foam surround. This simplifies both the production of the components and also the mounting of the vehicle roof system. The reinforcing plate is preferably foamed to a fixed glass element of the rear roof module by using this foam surround. Thus, the foam surround can also simultaneously form a marginal foam surround on the front edge of the fixed glass element (or a circumferential marginal foam surround) and optionally have further functional structures, such as a groove to receive a seal.

Particularly preferred is an embodiment in which the reinforcing plate is bonded to a fixed glass element of the rear roof module. This bond can in particular be made independently and separately from a marginal foam surround of the fixed glass element.

Preferably, the two roof modules are formed in such a way as to be mounted in or on the roof opening from above. The displaceable cover can have a glass pane and the rear roof module can have a fixed glass element. The two roof modules are formed here such that in order to assemble the roof modules, the displaceable cover and the fixed glass element can be mounted in or on the roof opening(s) from above. This particularly preferred refinement of the invention is therefore a “top-load” (TL) vehicle roof system.

Preferably, the TL vehicle roof system is a spoiler roof, in which a displaceable cover of the front roof module can be displaced at least partly over a fixed glass element of the rear roof module in order to partly expose the roof opening.

In a further preferred refinement of the invention (before or during the mounting) of the roof modules on a vehicle roof, the reinforcing plate is connected to the front or rear frame from below, in particular riveted, screwed or bonded.

In the method according to the invention, firstly the front frame and the rear frame are arranged in the region of the roof opening. Then (before or after the displaceable cover has been mounted from above), a fixed glass element of the rear roof module is likewise inserted into the roof opening from above, that is to say from a region outside a vehicle interior, and connected to the front frame by means of the reinforcing plate, in particular bonded.

The front frame preferably has a frame transverse component in the region of the central strut part, to the underside of which an upper side of the reinforcing plate is connected, in particular bonded.

Even if, in the present case, a fixed glass element is generally provided for the rear roof module, then the invention is not intended to be restricted to the use of a fixed glass element. Fixedly installed covers, for example made of plastic or metal or a combination thereof, are to be viewed as equivalent within the context of the invention.

### BRIEF DESCRIPTION OF DRAWINGS

The invention is explained in more detail below by way of example with reference to the appended drawings.

FIG. 1 shows a schematic view of a vehicle roof system according to the invention;

FIG. 2 shows a cross section through the vehicle roof system of FIG. 1; and

FIG. 3 shows a cross section through an alternative embodiment of the vehicle roof system of FIG. 1.

### DETAILED DESCRIPTION

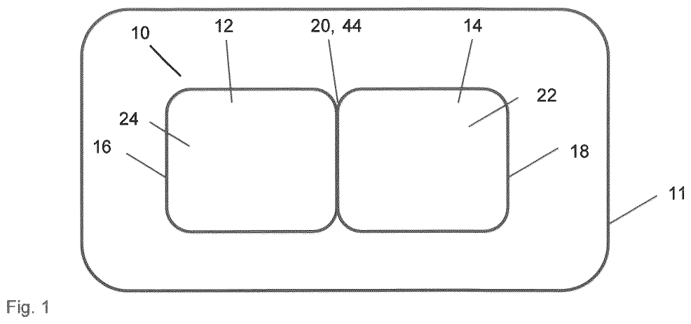

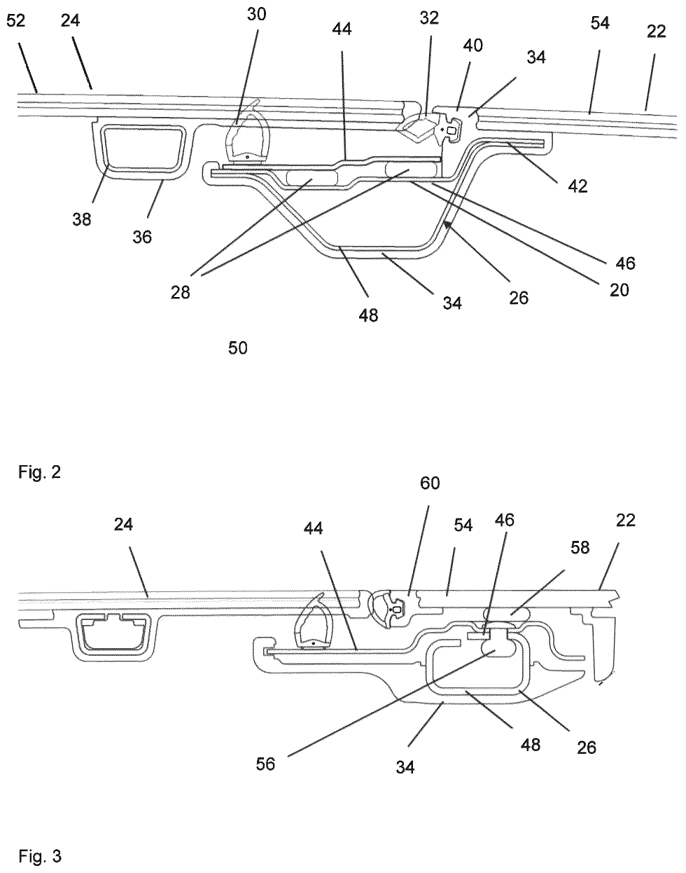

FIGS. 1 and 2 show a vehicle roof system 10 according to the invention for mounting on a vehicle roof 11. The vehicle roof system 10 has a front roof module 12 and a rear roof module 14. The front roof module 12 includes a front frame 16, the rear roof module 14 includes a rear frame 18. A central strut part 20 of the rear roof module 14 is arranged between the two roof modules 12 and 14.

During the mounting, the two frames 16 and 18 can be arranged on the vehicle roof independently of each other as individual components or as a coherent, approximately 8-shaped, frame component.

The rear roof module 14 has a fixed glass element 22 with a glass pane 54, which fixedly closes an associated rear region of a roof opening. The front roof module 12 includes a displaceable cover 24 with a glass pane 52, which can optionally expose or close a front region of the roof opening.

The two roof modules 12 and 14 form a so-called “top-load” (TL) system, in which the cover 24 and the fixed glass element 22 are mounted in or on the vehicle roof 11 from above, separately from each other.

On the rear roof module 14, a reinforcing plate 26, which forms the central strut part 20 with an upper part 46, is foamed on by means of a foam surround 34 (for example made of a polyurethane (PU) foam). An extension 42 on a rear side of the reinforcing plate 26 is foamed into a foam surround 34 of the fixed glass element 22 in order to configure this attachment. The foam surround 34 can be formed as a circumferential marginal foam surround of the fixed glass element 22.

The reinforcing plate 26 is formed as a hollow body and, in the present embodiment, has an upper part 46 and the lower part 48, which are welded to each other. The upper part 46 of the reinforcing plate 26 forms the central strut part 20.

The two roof modules 12 and 14 in this exemplary embodiment are firmly connected to each other in the region of the central strut part 20 only during the mounting. For this purpose, the fixed glass element 22 is mounted on the vehicle roof system 10 from above, for example bonded in. The central strut part 20 is also bonded to a frame transverse component 44 of the front frame 16 from below by means of at least a further adhesive bead 28. The bond is thus formed between the upper part 46 of the reinforcing plate 26 and an underside of the frame transverse component 44 of the front frame 16. Alternatively, the two roof modules 12 and 14 are provided preassembled as a semi-finished product, i.e. connected to each other.

In addition, a first seal 30, which seals off the front frame 16 with respect to an underside of the cover 24, is arranged on an upper side of the frame transverse component 44. The foam surround 34 has a groove 40, which is used to receive a second seal 32, which seals off the fixed glass element relative to a marginal foam surround 36 on a rear edge of the cover 24. Likewise foamed into the marginal foam surround 36 on the rear edge of the cover 24 is a sheet-metal inset 38, which increases the torsional rigidity of the cover 24. The marginal foam surround 36 is preferably designed to run around the entire cover outer edge.

The foam surround 34 according to the invention is not just used to attach the reinforcing plate 26 to the fixed glass element 22, instead it simultaneously forms a protective surface for any possible head impact of a vehicle occupant. For this purpose, the foam surround 34 is extended at least over the region of the lower part 48 of the reinforcing plate 26 that is visible from a vehicle interior 50. Therefore, the foam surround 34 also serves as a visual improvement as a result of the screen which it forms, in that it covers bare metal parts of the reinforcing plate 26 which would otherwise be visible from the vehicle interior.

FIG. 3 shows a refinement of the present invention that is an alternative to the embodiment from FIG. 2.

In the embodiment of FIG. 3, the reinforcing plate 26 is not produced from two separate parts which are connected to each other, for example welded, riveted or screwed, instead the reinforcing plate 26 is formed in one piece with its upper part 46 and its lower part 48. The reinforcing plate 26 can thus be produced more simply from a single sheet metal part which is reshaped by bending, for example into a square tube.

In the embodiment of FIG. 3, the reinforcing plate 26 is also connected to the fixed glass element 22 by means of a bond 58. Therefore, the fixed glass element 22 here has a separate marginal foam surround 60, which is not formed by the foam surround 34 of the reinforcing plate 26 (as in the embodiment of FIG. 2).

In addition, in the embodiment of FIG. 3, the reinforcing plate 26 is not bonded to the frame transverse component 44 but connected by means of a riveted connection 56. As a further alternative, a screw fixing can also be used.

As a result of the present invention, it is possible to dispense with the mounting of an additional separate head protection cover and/or a separate screen, as is necessary in known TL systems. According to the invention, this reduces the number of components to be mounted and thus the production costs.

### LIST OF REFERENCE SYMBOLS

10 Vehicle roof system
11 Vehicle roof
12 Front roof module
14 Rear roof module
16 Front frame
18 Rear frame
20 Central strut part
22 Fixed glass element
24 Displaceable cover
26 Reinforcing plate
28 Adhesive bead
30 First seal
32 Second seal
34 Foam surround
36 Marginal foam surround of cover
38 Sheet-metal insert
40 Groove
42 Extension
44 Frame transverse component of 16
46 Upper part of 26
48 Lower part of 26
50 Vehicle interior
52 Glass pane
54 Glass pane
56 Riveted connection
58 Adhesive bond
60 Marginal foam surround of 54

1. Vehicle roof system for mounting on a vehicle roof, wherein the vehicle roof system has a front roof module and a rear roof module, wherein the front roof module has a front frame and the rear roof module has a rear frame, and the rear roof module fixedly closes a rear region of a roof opening of the vehicle roof or a rear roof opening, and the front roof module can partly expose or completely close a front region of the roof opening or a front roof opening by means of a displaceable cover, wherein a central strut part is arranged between the two roof modules, transversely with respect to a vehicle longitudinal axis,
wherein
a reinforcing plate is foamed or bonded on the rear roof module and is connected to the front frame or to the rear frame, wherein the reinforcing plate forms the central strut part.

2. Vehicle roof system according to claim 1, wherein the front frame has a frame transverse component in a rear region in the direction of travel or the rear frame has a frame transverse component in a front region in the direction of travel, to which the reinforcing plate is connected.

3. Vehicle roof system according to claim 2, wherein the front frame is designed to run around the front region of the roof opening or the front roof opening.

4. Vehicle roof system according to claim 3, wherein the rear frame is arranged in the region of the side edges and the rear edge of the rear region of the roof opening or the rear roof opening.

5. Vehicle roof system according to claim 1, wherein the front frame and the rear frame form a unified roof frame, which is designed as an 8-shaped frame component, and the reinforcing plate is connected to this frame component.

6. Vehicle roof system according to claim 3, wherein the reinforcing plate is designed as a hollow body with an upper part which forms the central strut part, and a lower part which faces a vehicle interior, wherein the upper and lower part are designed as an integral component or, alternatively, form two preferably welded shells connected to each other.

7. Vehicle roof system according to claim 1, wherein the reinforcing plate has a foam surround, at least on an underside which faces a vehicle interior.

8. Vehicle roof system according to claim 7, wherein the reinforcing plate is foamed to the rear roof module by means of the foam surround, and the foam surround also forms a marginal foam surround of a fixed glass element of the rear roof module.

9. Vehicle roof system according to claim 7, wherein the reinforcing plate is bonded to a fixed glass element of the rear roof module.

10. Vehicle roof system according to claim 1, wherein the two roof modules are designed to be mounted in or on the roof opening or the roof openings from a region outside a vehicle interior.

11. Vehicle roof system according to claim 1, wherein the displaceable cover has a glass pane, and the rear roof module has a fixed glass element, and the two roof modules are formed such that the displaceable cover and the fixed glass element can be mounted in or on the roof opening from above.

12. Vehicle roof system according to claim 1, wherein it is a spoiler roof, in which a displaceable cover of the front roof module can be displaced at least partly over a fixed glass element of the rear roof module to partly expose the roof opening.

13. Vehicle roof system according to claim 1, wherein the reinforcing plate is bonded or screwed or riveted from below onto the front or rear frame or on a frame component which has the front and the rear frame.

14. Vehicle roof system according to claim 1, wherein the reinforcing plate is riveted, screwed or bonded to the front frame or to the rear frame.

15. Vehicle roof system according to claim 4, wherein the reinforcing plate is designed as a hollow body with an upper part which forms the central strut part, and a lower part which faces a vehicle interior, wherein the upper and lower part are designed as an integral component or, alternatively, form two preferably welded shells connected to each other.

16. Method for mounting a vehicle roof system according to claim 1, wherein, in the course of the method:
the front frame and the rear frame are arranged in the region of the roof opening, and then
a fixed glass element of the rear roof module is inserted into the roof opening from above and connected to a frame transverse component by means of the reinforcing plate, in particular riveted, screwed or bonded, wherein the frame transverse component is formed on the front frame in a rear region in the direction of travel or on the rear frame in a front region in the direction of travel, preferably perpendicularly and transversely with respect to the vehicle longitudinal axis.

17. Method according to claim 14, wherein in the region of the central strut part, the front frame or the rear frame has the frame transverse component, to the underside of which an upper side of the reinforcing plate is connected.

18. Method according to claim 14, wherein the fixed glass element of the rear roof module is riveted, screwed or bonded to the frame transverse component by means of the reinforcing plate.
